(19) United States
(12) Patent Application Publication
(10) Pub. No.: US 2008/0037458 A1
(43) Pub. Date: Feb. 14, 2008

(54) Dynamic adjustment of frame detection sensitivity in wireless devices

(76) Inventor: Jorge Myszne, Zikhron Ya'akov (IL)

Correspondence Address: INTEL CORPORATION;C/O INTELLEVATE, LLC, P.O. BOX 52050, MINNEAPOLIS, MN, 55402, US

(21) Appl. No.: 11/478,149

(22) Filed: Jun. 28, 2006

(51) Int. Cl. H04B 7/204

(52) U.S. Cl. 370/319

(57) ABSTRACT

Methods and apparatuses for dynamically adjusting the sensitivity of a receiver for detecting air frames destined for the receiver may generally include determining a number of false frames previously detected by a wireless receiver in a period of time and adjusting a threshold to be compared with correlation output used to detect frames based on the determined number of false frames previously detected. In this manner, the sensitivity for a receiver in detecting frames may be increased or decreased based on the current environment in the wireless network. Additional embodiments and variations are also disclosed.

### BACKGROUND OF THE INVENTION

It is becoming more important to be able to provide telecommunication services to subscribers which are relatively inexpensive as compared to cable and other land line technologies. Further, the increased use of mobile applications has resulted in much focus on developing wireless systems capable of delivering large amounts of data at high speed.

Development of more efficient and higher bandwidth wireless networks has become increasingly important and addressing issues of how to maximize efficiencies of such networks and/or individual network devices is an ongoing issue. One such issue relates to efficient detection of signals destined to network devices. For example, Wireless Local Area Networks (WLANs) are becoming ubiquitous in today's corporate, home and public environments. The quantity and density of wireless LAN devices are rapidly growing. This creates difficulties in the concurrent work of different devices on the same radio frequency (RF), as well as in the coexistence of different wireless devices working on overlapping and adjacent RF frequencies. WLAN performance can be impacted by a variety of RF-based interference. Notable sources of interference include cordless phones, microwave ovens, Bluetooth devices and internal platform noise coming from the LCD and/or power supplies. The quality of the wireless link is continuously changing due to both mobility of wireless devices and changes in the environment itself. All the above mentioned factors require the wireless devices to optimize the performance for the current condition which is an increasing challenge for designers of wireless devices.

### BRIEF DESCRIPTION OF THE DRAWING

Aspects, features and advantages of embodiments of the present invention will become apparent from the following description of the invention in reference to the appended drawing in which like numerals denote like elements and in which:

FIG. 1 is block diagram of an example wireless network according to various embodiments;

FIG. 2 is a functional block diagram of an exemplary frame detection circuit according to one or more embodiments of the invention;

FIG. 3 is a flow diagram of a method for adjusting a sensitivity of detecting communications according to an example embodiment of the invention; and

FIG. 4 is a block diagram showing an example wireless apparatus configured to perform one or more the inventive methods described herein.

### DETAILED DESCRIPTION OF THE INVENTION

While the following detailed description may describe example embodiments of the present invention in relation to wireless local area networks (WLANs), the invention is not limited thereto and can be applied to other types of wireless networks where similar advantages may be obtained. Such networks specifically include, if applicable, broadband wireless metropolitan area networks (WMANs), wireless personal area networks (WPANs) and/or wireless wide area networks (WWANs) such a cellular networks and the like. Further, while specific embodiments may be described in reference to wireless networks utilizing Orthogonal Frequency Division Multiplexing (OFDM) or Orthogonal Frequency Division Multiple Access (OFDMA), the embodiments of present invention are not limited thereto and, for example, can be implemented using other types of synchronized air interfaces where suitably applicable.

The following inventive embodiments may be used in a variety of applications including transceivers or receivers of a radio system. Radio systems specifically included within the scope of the present invention include, but are not limited to, network interface cards (NICs), network adaptors, mobile stations, fixed or mobile access points, mesh stations, base stations, hybrid coordinators (HCs), gateways, bridges, hubs, routers or other network peripherals. Further, the radio systems within the scope of the invention may include cellular radiotelephone systems, satellite systems, personal communication systems (PCS), two-way radio systems and two-way pagers as well as computing devices including such radio systems such as personal computers (PCs) and related peripherals, personal digital assistants (PDAs), personal computing accessories, hand-held communication devices and all existing and future arising systems which may be related in nature and to which the principles of the inventive embodiments could be suitably applied.

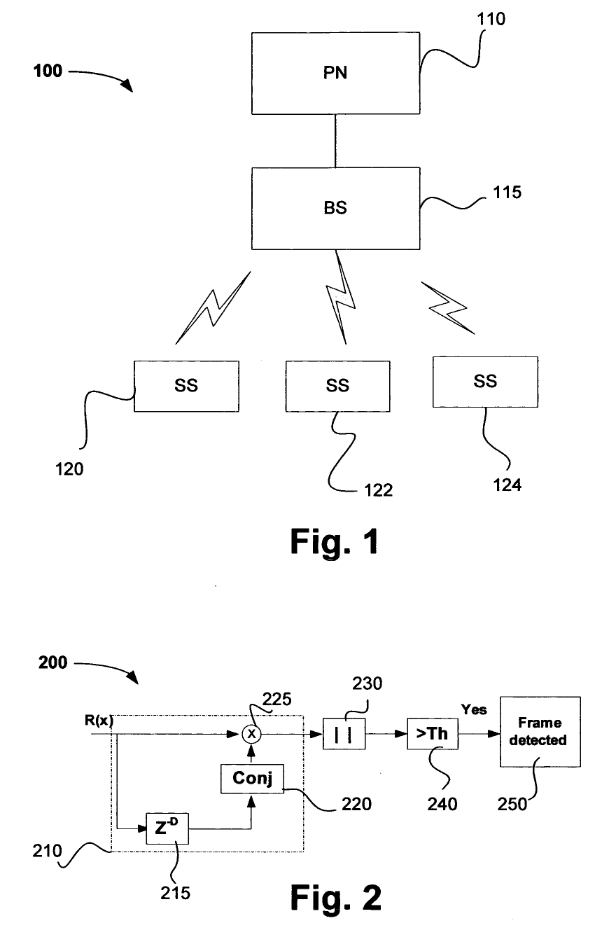

Turning to FIG. 1, a wireless communication network 100 according to various inventive embodiments may be any wireless system capable of facilitating wireless access between a provider network (PN) 110 and one or more subscriber stations 120-124 including mobile or fixed subscribers. For example, network 100 may be configured to use one or more protocols specified in by the Institute of Electrical and Electronics Engineers (IEEE) 802.11 a, b, g or n standards such as IEEE 802.11a-1999; IEEE 802.11b-1999/Cor1-2001; IEEE 802.11g-2003; and/or IEEE 802.11n (not yet published) or in the IEEE 802.16 standards for broadband wireless access such as IEEE 802.16-2004/Corn-2005 or IEEE 802.16e-2005 although the inventive embodiments are not limited in this respect. Alternatively or in addition, network 100 may use protocols compatible with a 3^{rd} Generation Partnership Project (3GPP) Long Term Evolution (LTE) mobile phone network or any protocols for WPANs or WWANs

In the IEEE 802.16 standards (sometimes referred to as WiMAX, an acronym that stands for Worldwide Interoperability for Microwave Access), two principle communicating wireless network nodes are defined including the Base Station (BS) (e.g., base station 115) and the Subscriber Station (SS) (e.g., subscriber stations 120, 122, 124). The functional equivalent for base station 115 in WLANs is referred to as an access point (AP) and subscriber stations 120,122, 124 might be referred to as a station or (STA). However, the terms base station and subscriber station are used in a generic manner throughout this specification and their denotation in this respect is in no way intended to limit the inventive embodiments to any particular type of network or protocols.

In the example configuration of FIG. 1, base station 115 is a managing entity which controls the wireless communications between subscriber stations 120-124 and provider network 110 and/or potentially between the subscriber stations themselves. Subscriber stations 120-124 in turn, may facilitate various service connections of other devices (not shown) to network 110 via a private or public local area network (LAN), although the embodiments are not limited in this respect.

In the physical (PHY) layer or air interface, communications between base station 115 and subscriber stations 120-124 may be facilitated using synchronized transmit time intervals (TTls) often referred to as an air frame or a frame (also sometimes referred to as a packet). In one example embodiment, uplink and downlink communications are maintained by sending frames at intervals (e.g. every 5 ms) using Complementary Code Keying (CCK), OFDM, OFDMA modulation or some combination of modulation techniques although the inventive embodiments are not limited to any particular modulation scheme.

Each radio frame may generally consist of a preamble, header and a data payload (depending on the type of network protocols used). The preamble and header of a frame are generally used to alert all radios sharing a common channel that data transmission is beginning. The preamble may be a sequence of 1's and 0's which enables radios to get ready to receive data (e.g., a wake-up call). The header generally follows the preamble and may convey important pieces of information regarding the data payload of the frame.

The detection of frames by a wireless receiver may be a trade-off between false frame detections (e.g., detection of noise as a valid frame) and misdetections (e.g., missed the detection of a valid frame). If the receiving device is higher in detecting sensitivity, the probability of misdetection decreases while the probability of false detections increases. Conversely, if the receiving device has lower frame detection sensitivity, the probability of misdetection increases and the false detections decreases.

Referring to FIG. 2, a functional block diagram for a frame detection circuit 200 is shown where a received input signal R(x) is correlated by auto-correlator 210 and the modulus 230 or absolute value of the correlation is compared to a threshold value 240 in order to declare a frame as being detected 250. Correlators are generally used in receivers to find pattems in a received signals such as the frame preamble. Auto-correlation is the process where the received signal R(x) is compared with itself (e.g., split and a delayed 215 conjugate 220 of the signal is multiplied 225 with the original signal) to produce a correlation value. Cross-correlation, which is also applicable to the inventive embodiments, is the process where the received signal is compared with a different signal such as a stored signal pattern. The frame detection sensitivity of detector 200 may therefore be defined by the threshold value 240 where, for example, a lower threshold value means more sensitive frame detection and a higher threshold value means less sensitive frame detection.

According to various embodiments of the present invention, sensitivity threshold value 240 may be dynamically adjusted as conditions of the network environment change. For example, if there is no or relatively low noise in the frequencies where a wireless receiver is operating, threshold value 240 may be set to a minimum value, thus maximizing the sensitivity of frame detection. However, if new clients or RF interferers appear on the same or nearby channel, the sensitivity of frame detection may be decreased by increasing threshold value 240 to an optimum working point (e.g., where maximum throughput is achieved for those specific conditions) or to its maximum value.

In a closed-loop or other type of feedback network, the current conditions of the network may be determined using various channel state information (CSI) such as a signal-to-noise ratio (SNR) or signal-to-interference plus noise ratio (SINR).

However, in certain of the inventive embodiments, CSI is not necessary as the channel conditions may be determined based on a number of previous false frame detections which occur over a period of time, referred to herein as a false frame detection rate. For example, when a frame is detected by passing the correlation threshold comparison described above with respect to FIG. 2, the PHY and/or medium access control (MAC) headers which typically follow the frame preamble may be examined. By looking at those headers, the wireless receiver may determine whether a detected frame is actually a real frame or a false frame. In certain embodiments, false frames can be detected and logged by looking for a cyclic check redundancy (CRC) error, parity error or invalid combinations in detected frames.

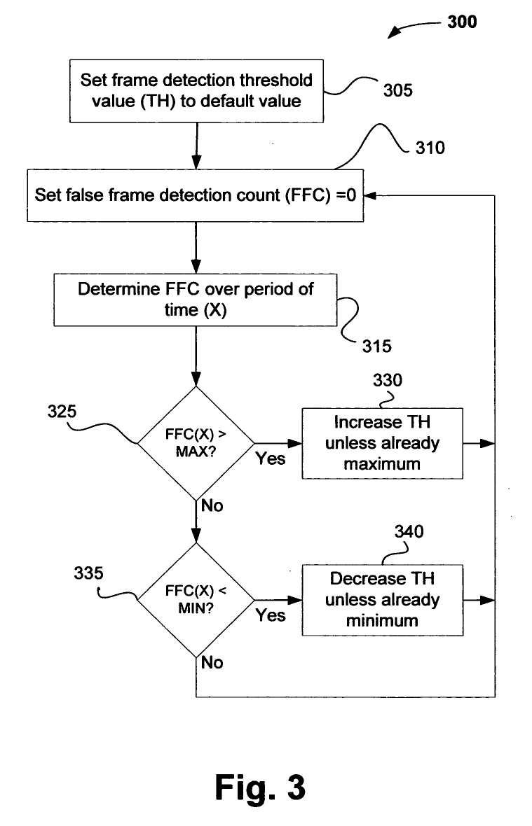

Turning to FIG. 3, an exemplary method 300 for communicating in a wireless network may generally begin by setting 305 a default frame detection threshold (TH) to a default value, which in certain embodiments may be a mid range sensitivity value. Additionally, a false frame detection count (FFC) may be initialized or reset 310 to zero. Thereafter, the number of false frame detections occurring over a given period of time (X), i.e., false frame detection rate (FFC(X)) may be determined 315.

If 325 the false frame detection rate FFC(X) exceeds the maximum desired (MAX), the frame detection threshold (TH) may be increased 330, if it is not already set at its maximum value. Conversely, if 335 FFC(X) is less than what is considered to be an minimum acceptable rate of false detections (MIN), the detection sensitivity may be increased by reducing 340 TH, assuming it is not already set at its minimum value. After adjusting 330 or 340 TH if necessary, the false frame detection count may begin 310 again and the process continually repeated. If 325, 335 the false frame detection rate FFC(X) ranges in between the MAX and MIN values, no adjustment may be desired.

The amount of threshold adjustments 330, 340 and/or the minimums and maximums for TH and FFC(X) may be selected at the discretion of the network designer. In certain embodiments, threshold adjustments 330, 340 may be made in small increments so as not over compensate in one direction or another. In other embodiments, there may be only two or three TH values (e.g., low, med or high), ranging between 0.1 and 1, that may be available for selection. It should be recognized that the specific amount or manner in which the threshold for frame detection sensitivity may be adjusted is not limited by the specific embodiments discussed herein. However, in one non-limiting example implementation, the frame detection threshold value (TH) may be set 305 to a default value of 0.8 where the minimum TH=0.5 and maximum TH=1. Further, in this example embodiment, FFC(X) MAX may be set to 20/800 ms with the FFC(X) MIN set to 3/800 ms, although the inventive embodiments are not limited in this respect.

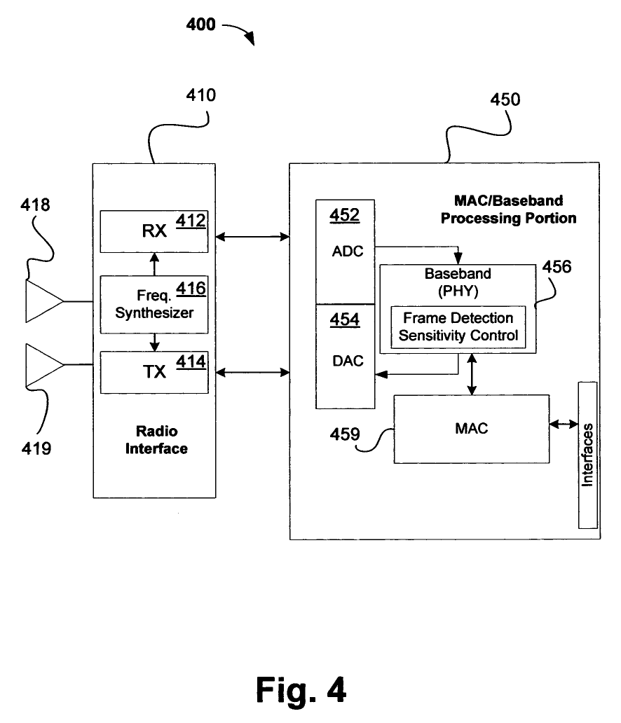

Referring to FIG. 4, an apparatus 400 for use in a wireless network may include a processing circuit 450 including logic (e.g., hard circuitry, processor and software, or combination thereof) to determine the false frame detection rate and/or adjust the sensitivity of frame detection as described in one or more of the processes above. In certain non-limiting embodiments, apparatus 400 may generally include a radio frequency (RF) interface 410 and a medium access controller (MAC)/baseband processor portion 450.

In one example embodiment, RF interface 410 may be any component or combination of components adapted to send and receive single carrier or multi-carrier modulated signals (e.g., CCK or OFDM) although the inventive embodiments are not limited to any specific over-the-air interface or modulation scheme. RF interface 410 may include, for example, a receiver 412, a transmitter 414 and/or a frequency synthesizer 416. Interface 410 may also include bias controls, a crystal oscillator and/or one or more antennas 418, 419 if desired. Furthermore, RF interface 410 may alternatively or additionally use external voltage-controlled oscillators (VCOs), surface acoustic wave filters, intermediate frequency (IF) filters and/or radio frequency (RF) filters as desired. Due to the variety of potential RF interface designs an expansive description thereof is omitted.

Processing circuit 450 may communicate with RF interface 410 to process receive/transmit signals and may include, by way of example only, an analog-to-digital converter 452 for down converting received signals, a digital-to-analog converter 454 for up converting signals for transmission. Further, circuit 450 may include a baseband processing circuit 456 for PHY link layer processing of respective receive/transmit signals. Processing portion 450 may also include or be comprised of a processing circuit 459 for medium access control (MAC)/data link layer processing.

In certain embodiments of the present invention, PHY processing circuit 456 may include a frame detection module with sensitivity control, in combination with additional circuitry such as a buffer memory (not shown), and may function to determine false frame detection rates, correlate and compare signals for frame detection and/or adjust a frame detection sensitivity threshold as in the embodiments previously described. Alternatively or in addition, MAC processing circuit 459 may share processing for certain of these functions or perform these processes independent of PHY processing circuit 456. MAC and PHY processing may also be integrated into a single circuit if desired.

Apparatus 400 may be, for example, a base station, an access point, a hybrid coordinator, a wireless router or a NIC and/or network adaptor for computing devices. Accordingly, the previously described functions and/or specific configurations of apparatus 400 could be included or omitted as suitably desired. In some embodiments apparatus 400 may be configured to be compatible with protocols and frequencies associated one or more of the IEEE 802.11, 802.15 and/or 802.16 standards for respective WLANs, WPANs and/or broadband wireless networks, although the embodiments are not limited in this respect.

Embodiments of apparatus 400 may be implemented using single input single output (SISO) architectures. However, as shown in FIG. 4, certain preferred implementations may include multiple antennas (e.g., 418, 419) for transmission and/or reception using adaptive antenna techniques for beamforming or spatial division multiple access (SDMA) and/or using multiple input multiple output (MIMO) communication techniques.

The components and features of station 400 may be implemented using any combination of discrete circuitry, application specific integrated circuits (ASICs), logic gates and/or single chip architectures. Further, the features of apparatus 400 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the example apparatus 400 shown in the block diagram of FIG. 4 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
determining a number of false frames detected by a wireless receiver in a period of time; and
adjusting a frame detection sensitivity threshold of the wireless receiver based, at least in part, on the determined number of false frames detected.

2. The method of claim 1 further comprising detecting frames by comparing the frame detection sensitivity threshold with an output of an auto-correlator.

3. The method of claim 1 further comprising detecting frames by comparing the frame detection sensitivity threshold with an output of a cross-correlator.

4. The method of claim 2 wherein the frames detected by the wireless receiver comprise at least one of orthogonal frequency division multiplexing (OFDM) modulated frames or orthogonal frequency division multiple access (OFDMA) modulated frames.

5. The method of claim 1 wherein adjusting the frame detection sensitivity threshold comprises incrementing or decrementing a threshold value for frame detection in response to the number of false frames detected in the period of time.

6. The method of claim 1 wherein the wireless receiver comprises one of a wireless personal areas network (WPAN) receiver or a wireless local area network (WLAN) receiver.

7. The method of claim 1 wherein the wireless receiver comprises one of a wireless metropolitan area network (WMAN) receiver or a wireless wide area network (WWAN) receiver.

8. An apparatus for wireless communication, the apparatus comprising:
a frame detection sensitivity adjustment circuit to dynamically adjust a threshold value used to detect frames based on a false frame detection rate.

9. The apparatus of claim 8 further comprising a correlator to produce a value from a received signal for comparison with the threshold value, wherein if a modulus of the value from the correlator exceeds the threshold value, a frame is detected.

10. The apparatus of claim 8 further comprising a radio frequency (RF) interface communicatively coupled to frame detection sensitivity adjustment circuit.

11. The apparatus of claim 9 wherein the correlator comprises one of a cross-correlator or an auto-correlator.

12. The apparatus of claim 8 wherein the frame detection sensitivity adjustment circuit is operative to increment or decrement the threshold value between a maximum threshold value and a minimum threshold value depending on the false frame detection rate.

13. The apparatus of claim 8 wherein the apparatus comprises a wireless local area network (WLAN) device using protocols compatible with one or more of the Institute of Electrical and Electronic Engineers (IEEE) 802.11 standards.

14. The apparatus of claim 8 wherein the apparatus comprises a wireless metropolitan area network (WMAN) device using protocols compatible with one or more of the IEEE 802.16 standards.

15. An article of manufacture comprising a tangible medium storing machine readable instructions, the machine readable instructions, when executed by a processing device, result in:
adjusting a threshold value used to detect frames directed to a wireless device based, at least in part, on a number of false frames previously detected at the wireless receiver in a period of time.

16. The article claim 15 further comprising machine readable instructions, when executed by the processing device, result in:
determining the number of false frames detected by the wireless receiver in a given period of time.

17. The article of claim 15 further comprising machine readable instructions, when executed by the processing device, result in:
comparing the threshold value to a correlation value to detect a frame.

18. The article of claim 17 wherein the correlation value comprises a value determined by an auto-correlator.

19. A system for wireless communications, the system comprising:
a processing circuit to adjust a threshold value used to detect frames by a wireless receiver, wherein the threshold value is adjusted based, at least in part, on a number of previously detected invalid frames if any; and
a radio frequency (RF) interface circuit coupled to the processing circuit, the RF interface including at least two antennas and adapted for at least one of spatial division multiple access (SDMA) or multiple-input multiple-output (MIMO) communication.

20. The system of claim 19 further comprising a correlator coupled to the processing circuit and the RF interface circuit, wherein the processing circuit is configured to compare an output value of the correlator to the threshold value to detect frames at the wireless receiver.

21. The system of claim 19 wherein the correlator comprises a cross-correlator.

22. The system of claim 19 wherein the correlator comprises an auto-correlator.
